(19) United States
(12) Patent Application Publication
(10) Pub. No.: US 2025/0308270 A1
(43) Pub. Date: Oct. 2, 2025

(54) DATA VALIDATION AND LABELING

(71) Applicant: Lenovo (United States) Inc., Morrisville, NC (US)

(72) Inventors: João Paulo Gomes de Freitas, Recife (BR); Jampierre Vieira Rocha, Itambacuri (BR); Daniel Cândido de Souza, Recife (BR); Silvan Ferreira da Silva Júnior, Parnamirim (BR); Anderson Carlos Sousa e Santos, Campinas (BR); Jayne de Morais Silva, Campina Grande (BR); Marianna de Pinho Severo, Quixadá (BR); Vitor Casadei, Piracicaba (BR)

(21) Appl. No.: 18/622,188

(22) Filed: Mar. 29, 2024

(51) Int. Cl. G06V 20/70; G06F 21/62; G06V 10/764

(52) U.S. Cl. CPC G06V 20/70; G06F 21/6218; G06V 10/764; G06F 2221/2141

(57) ABSTRACT

A first image is displayed on a computer display device. The first image includes a high confidence label. Additional images are displayed on the computer display device. One or more of the additional images includes a low confidence label. Input is received from a user. The input includes a selection of a second image from the additional images including the low confidence label that matches the image comprising a high confidence label. The low confidence label of the second image is then modified. In an embodiment, a user is permitted to access a processor-based system when the user selects the second image that matches the image including the high confidence label.

### TECHNICAL FIELD

Embodiments described herein generally relate to the validation and labeling of data, and in an embodiment, by not by way of limitation, the validation and labeling of visual data, and in a more particular embodiment, the validation and labeling of sign language data and using the validation and labeling of the sign language data in a Captcha system.

### BACKGROUND

Many processor-based systems use a Captcha (Completely Automated Public Turing test to tell Computers and Humans Apart) protocol to decide whether to permit access to the system or not. A Captcha is a type of challenge-response test used in computing to determine whether the user is human in order to deter bot attacks and spam. For example, before accessing a website, the website may require a user to type in letters and/or numbers displayed in a particular font on the computer screen, or to simply check a box that states “I'm not a robot.”

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a diagram of a system to evaluate and update confidence labels of video data, according to some examples of the present disclosure.

FIG. 2 is a diagram of a reward system for use in connection with a labeling system, according to some examples of the present disclosure.

FIG. 3 is a diagram of another reward system for use in connection with a labeling system, according to some examples of the present disclosure.

FIG. 4 is a diagram of another reward system for use in connection with a labeling system, according to some examples of the present disclosure.

FIG. 5 is a diagram of another system to evaluate and update confidence labels of video data, according to some examples of the present disclosure.

FIGS. 6A, 6B, and 6C are a block diagram illustrating operations and features of a system to evaluate and update confidence labels of video data, according to some examples of the present disclosure.

FIG. 7 is a block diagram illustrating operations and features of another system to evaluate and update confidence labels of video data, according to some examples of the present disclosure.

FIG. 8 is a block diagram illustrating operations and features of another system to evaluate and update confidence labels of video data, according to some examples of the present disclosure.

FIG. 9 is a block diagram of a computer architecture upon which one or more embodiments of the present disclosure can execute according to some examples of the present disclosure.

### DETAILED DESCRIPTION

An embodiment relates to a method for the labeling of data. In a particular embodiment, the labeled data consist of sign language video data. Another embodiment creates datasets with these labeled data and uses the datasets for training machine learning algorithms. Yet another embodiment relates to providing a security tool that is accessible to people who know sign language. Still yet another embodiment relates to preventing access to computer-based systems by robots.

An embodiment consists of a video database. The videos can be isolated signs, compound signs, letter signs and/or number signs. The database can have videos labeled as being high confidence or low confidence. That is, the system can be highly confident in the meaning of a sign in the database or not so confident in the meaning of a sign in the database. The videos in the database can also have no labels associated with them. The system, when activated, displays a group of videos. Among these videos, one video is of a high confidence. The system then asks a user to select the videos that contain the same labels. That is, the user is asked to select the videos that include the same sign of the sign language. The system uses the high confidence signal as a basis, so that when the user interacts with the system, the system makes the decision to reaffirm that the labels are correct or incorrect, which can increase the confidence in the signals, change the label of the signal, reduce confidence in the labeled signals or even add the label when the video or data doesn't have a label. It is noted that these are just examples, and there are thus many additional scenarios or embodiments which would be apparent to those of skill in the art.

In an embodiment, a user must select the same signs as the sign of high confidence to access a system. This prevents robots from accessing the system. The system also assists in data labeling. In an embodiment, at least one of the videos is known with 100% certainty of its label. In other embodiments, other certainty levels between 90% and 100% can be used. In short, an embodiment provides a Captcha system for human actions recorded in videos. These actions can be any nature, such as a sign in a sign language, a dance sequence, a movement, a physical activity or a domestic activity.

If a user selects the known signal with the high confidence, and then also selects other signals with the same label (that is the same sign, the same object, the same letter or the same number), but that have a low confidence, the system increases the confidence of the low confidence signals. As will be explained in more detail below, the system can also do the same (that is, increase the confidence) for unselected signals because, by not selecting signals that have a different label, the system infers that the different signals really must have the correct label.

If the user selects the known high confidence signal with one or more signals with a different label, the system evaluates the confidence of each signal and how many times each signal has been subsequently labeled (and what their labels were) to determine whether the user got it right and whether a positive or negative weight will be given to the signals.

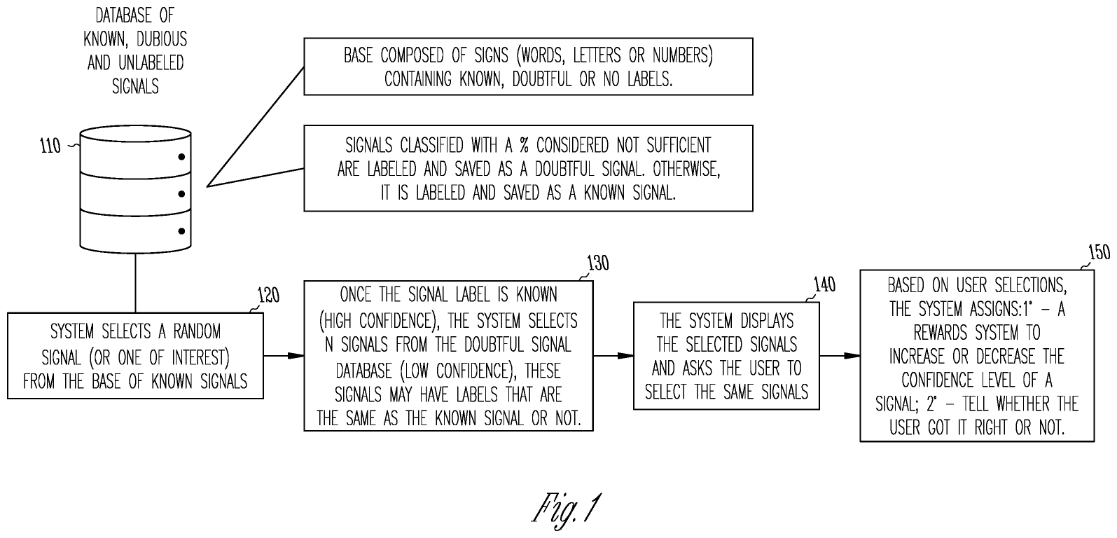

Referring to FIG. 1, in an embodiment, a database 110 includes signals or data of known labels, dubious labels and/or unlabeled signals. These signals can include signs, letters, numbers, words and/or video sequences. In an embodiment, signals that are classified with a percentage of less than 100% are considered not sufficient and are labeled and saved as a doubtful signal. Otherwise, the signal is labeled and saved as a known signal.

The system at 120 selects and displays a random signal (or one of interest) from the database 110 of known signals. This selected signal has a high confidence. At 130, the system then selects a number (N) of signals from the doubtful signal database (that is, low confidence). These signals may or may not have labels that are the same as the known signal. That is, they may or may not be the same sign in a sign language. At 140, the system displays the selected signals and asks the user to select the signals that are the same as the signal of high confidence. At 150, based on the user selections, the system assigns a rewards system (explained in more detail below) to increase or decrease the confidence level of a signal, and the system informs the user whether the user got it right or not.

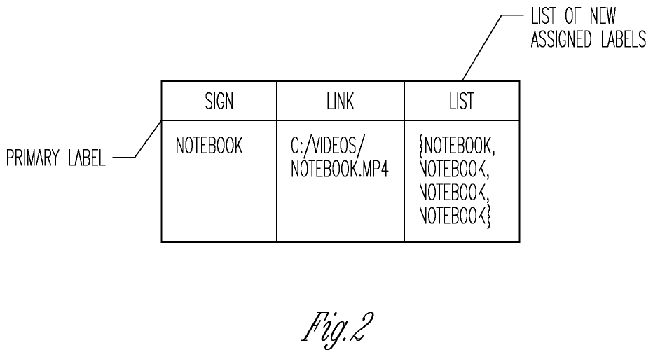

Referring to FIG. 2, the reward system calculates the percentage of new labels assigned to a particular signal, that is, the number of new labels entered by users for that signal. For example, if the system has a Label 1 for a signal A, but a number of users identify signal A with a different Label 2, then the system may determine that Label 1 for Signal A is not correct. Specifically, when there is a minimum of X new labels that were entered by users, and this number X of new labels is a certain percentage of all the different new labels entered by the users, the system considers the signal, which was previously uncertain, as a known signal, assigning the label that occurred most frequently (which may or may not be the primary label). For example, if the system had the signal A labeled as a sign for the word keyboard, but 70% of users labeled the signal A as a notebook, the system would update the label of the signal A as a notebook.

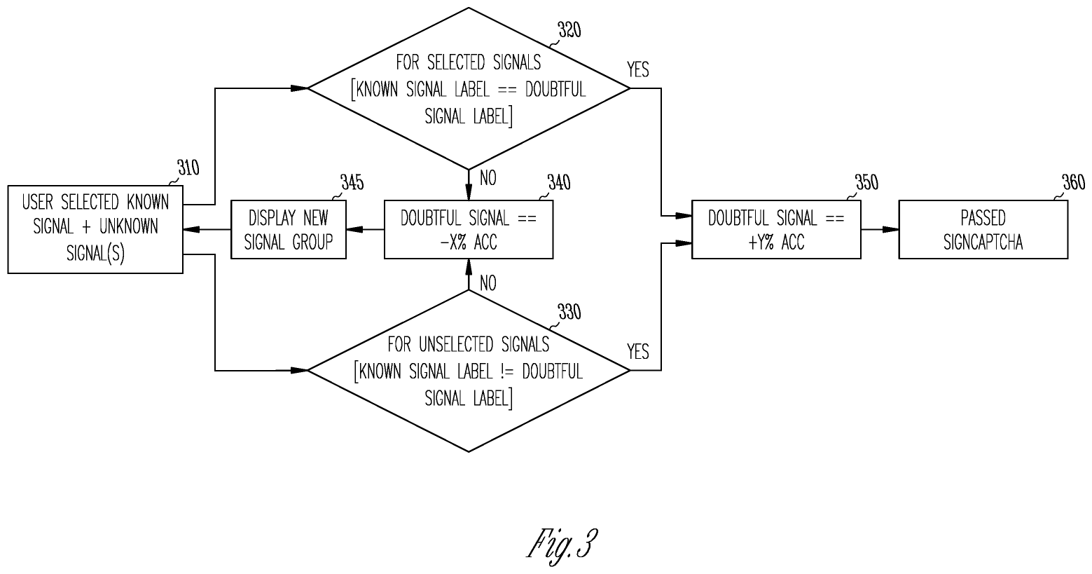

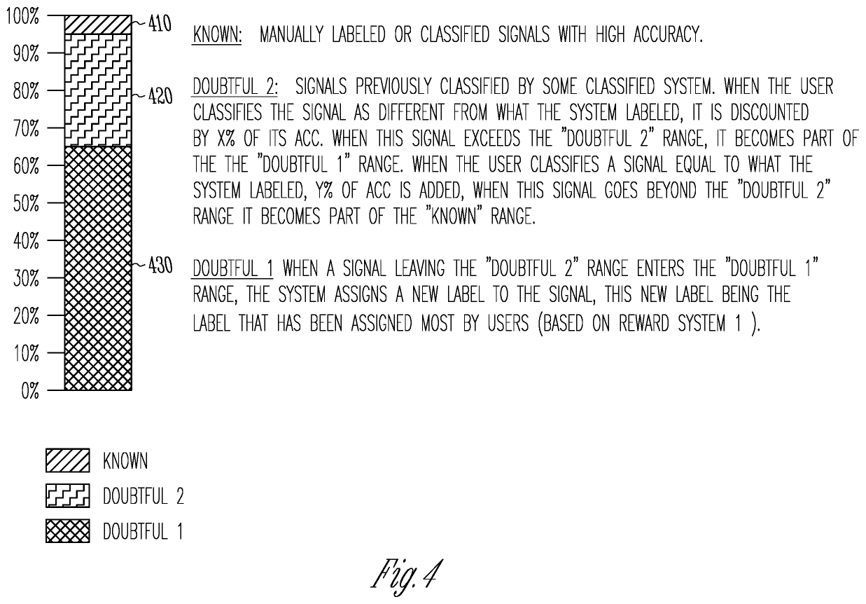

The reward system depicted in FIG. 3 discusses the manner in which an embodiment increases or decreases the accuracy (or confidence) of a signal. FIG. 4 discloses how a signal is classified based on its accuracy. It is noted that although in some scenarios some signals have their accuracy increased or reduced erroneously, over time these situations will become scarcer as the number of known signals increases.

Referring now specifically to FIG. 3, at 310, a user selects a known signal and one or more doubtful or unknown signals. At 320, if the user selects only the unknown signals that match the known signal, then at 350, the system assigns a greater accuracy to the selected unknown or doubtful signals, and at 360, the user has passed the Captcha test. Similarly, if the user selects only the unknown signals that match the known signal, then at 330, the system determines that the user was correct in not selecting the signals that do not match the known signal, and the system attributes greater accuracy to the doubtful signals at 350 that were not selected, as it understands that the fact that the unknown signal was not selected is because the main label of the known signal is correct. If the user selects less than all the doubtful signals that match the known signal, then the process proceeds through 320 and at 350 the system assigns greater accuracy to the selected doubtful signal (and the user passes the Captcha at 360).

In a somewhat different situation as indicated at 340, the user fails to select at least one signal that matches the known signal. In this scenario, even though the user made the mistake of not selecting the signal he was expected to select, the system attributes less accuracy to the dubious signal that was not selected, as it understands that the fact that it was not selected is because the main label is wrong. Then, at 345, a new group of signals is displayed to the user.

If the user selects dubious signals that both match and do not match the known signal, the system displays a new group of signals at 345. In this scenario, the accuracy of the selected signals does not change.

In another scenario at 320 and 340, when the user selects only signals that do not match the known signal, the system attributes less precision to the dubious signal that was selected since the system understands that the fact that it was selected is because the main label (the known signal) is incorrect, and at 345, a new group of signals is displayed to the user.

FIG. 4 illustrates another reward system for a labeling system. In this system, the known labels 410 are manually labeled or classified signals with high accuracy. The first set of doubtful signals 420 (Doubtful 2) are signals that have previously been classified by some classification system. When a user classifies the signal as different from what the system has the signal labeled as, its accuracy is discounted by a certain percentage. When this signal exceeds the “Doubtful 2” range, it becomes part of the doubtful signals 430 (Doubtful 1) range. When the user classifies a signal equal to what the system labeled, its accuracy is increased by a certain percentage. When this signal goes beyond the “Doubtful 2” range, it becomes part of the “Known” range. When a signal leaving the “Doubtful 2” range enters the “Doubtful 1” range, the system assigns a new label to the signal, this new label is the label that has been assigned most often by users (based on a reward system as disclosed herein). The values of the percentages can be chosen according to the desires of the operator of the system.

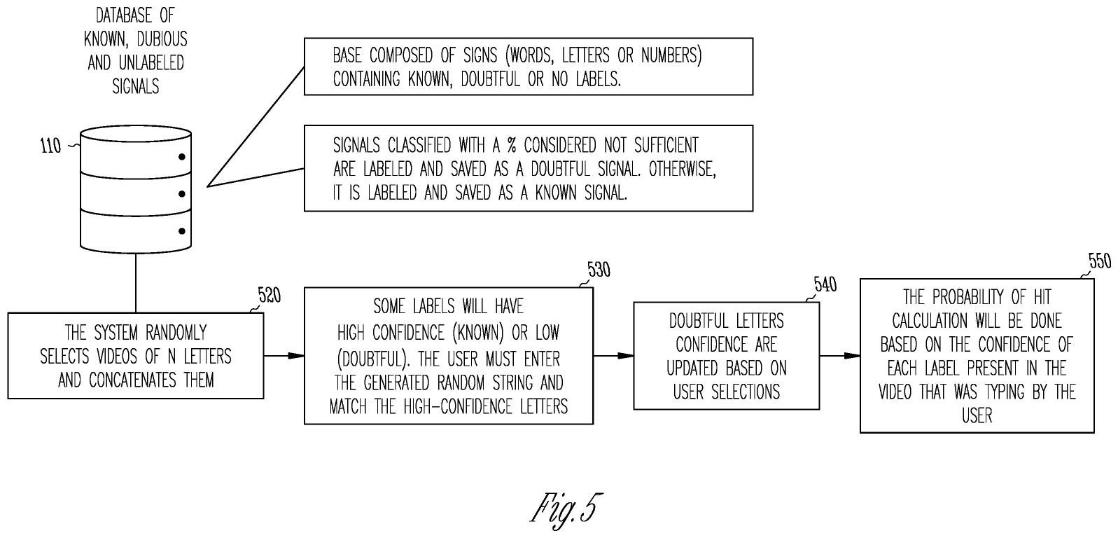

In another embodiment, which is illustrated in FIG. 5, the same database 110 is used that was used in connection with the system of FIG. 1 for the assignment of labels and confidences. The system at 520 randomly selects videos of a certain number (N) of letters (or other symbols) and concatenates them. As indicated at 530, some labels have a high confidence (known) and other labels have a low confidence (doubtful). The system requires that the user must enter the generated random string and match the high-confidence letters or symbols. At 540, the confidences of doubtful letters are updated based on the user selections. As indicated at 550, the probability of correct matches by the user is performed based on the confidence of each label present in the video.

For example, the system displays ABCD, wherein ABD are of a high confidence. If the user enters ABCD, the system infers that C is correct, and the system could update the confidence of C. Since the user has correctly identified ABD, the system, by inference, judges that C is correct. In another example, the system again displays ABCD, and ABD is of high confidence. If the user types EBGH, even though the user has correctly entered B, since the user has entered other signals incorrectly (A and D), the system, by inference, judges that the G is wrong.

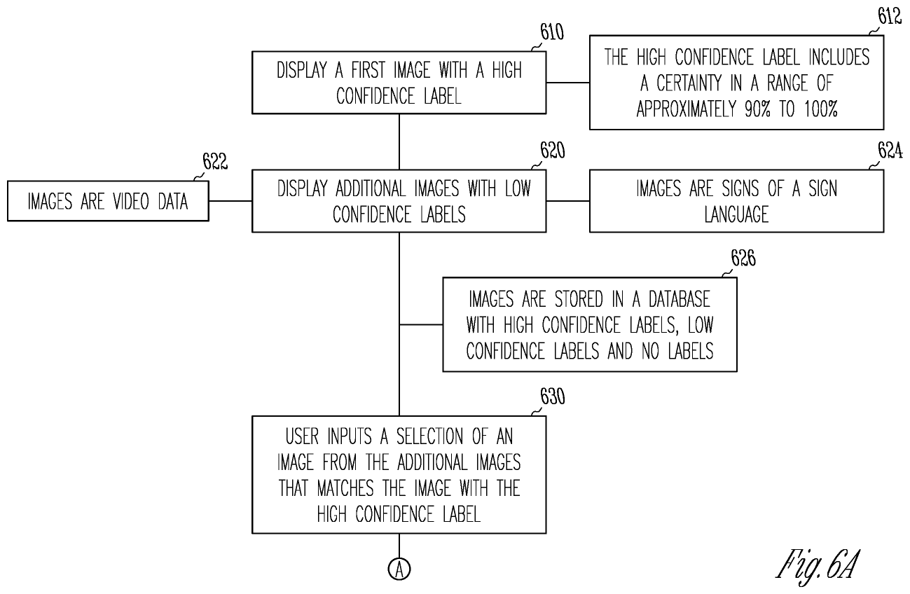

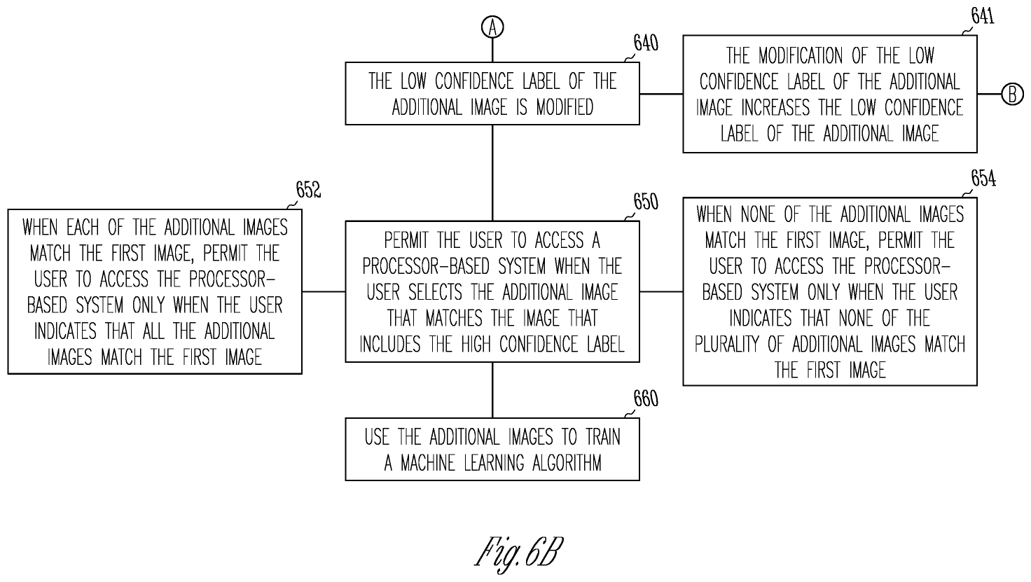

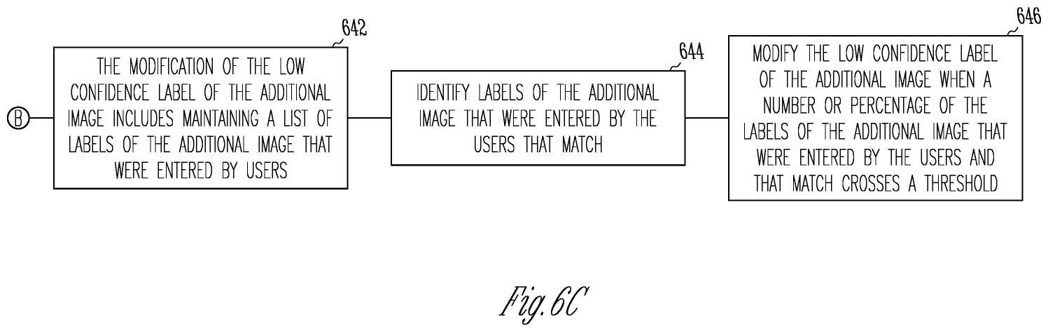

FIGS. 6A, 6B, 6C, 7 and 8 illustrate example embodiments of operations and features of a system to label data. FIGS. 6, 7 and 8 include a number of process and feature blocks 610-660, 710-740 and 810-852. Though arranged substantially serially in the examples of FIGS. 6A, 6B, 6C, 7 and 8, other examples may reorder the blocks, omit one or more blocks, and/or execute two or more blocks in parallel using multiple processors or a single processor organized as two or more virtual machines or sub-processors.

Referring first to FIGS. 6A, 6B, and 6C, at 610, a first image is displayed on a computer display device. The first image includes a high confidence label. In an embodiment, as indicated at 612, the high confidence label includes a certainty in a range of approximately 90% to 100%. That is, it is between 90% to 100% certain that the label associated with the image correctly identifies the content of the image such as a sign of a sign language.

At 620, additional images are displayed on the computer display device. One or more of the additional images include a low confidence label. The images can be video data (622). In another embodiment, the images can be signs of a sign language (624). As noted at 626, the images are stored in a database. The database includes images with high confidence labels, images with low confidence labels and images with no labels.

At 630, a user inputs a selection of a second image from the additional images that include the low confidence label. This second image should match the image that includes the high confidence label.

Then, at 640, the low confidence label of the second image is modified. Specifically, the system uses the input and intelligence of the user to upgrade images with low confidence label to images with high confidence labels. The modifying the low confidence label of the second image comprises increasing the low confidence label of the second image (641). More specifically, the modifying of the low confidence label of the second image includes maintaining a list of labels of the second image that were entered by a plurality of users (642), identifying labels of the second image that were entered by the plurality of users that match (644), and modifying the low confidence label of the second image when a number or percentage of the labels of the second image that were entered by the plurality of users and that match crosses a threshold (646).

As indicated at 650, the user is permitted to access a processor-based system when the user selects the second image that matches the image that includes the high confidence label. As indicated at 652, each of the additional images match the first image, and in this case, the user is permitted to access a processor-based system only when the user indicates that all the additional images match the first image. And as indicated at 654, none of the additional images match the first image, and the user is permitted to access a processor-based system only when the user indicates that none of the additional images match the first image.

At 660, the additional images are used to train a machine learning algorithm. In an embodiment, the additional images are used to train the machine learning algorithm when the confidences of the additional images have been upgraded to a high confidence label. The use of images with high confidence labels improves the quality of the training of the machine learning algorithm.

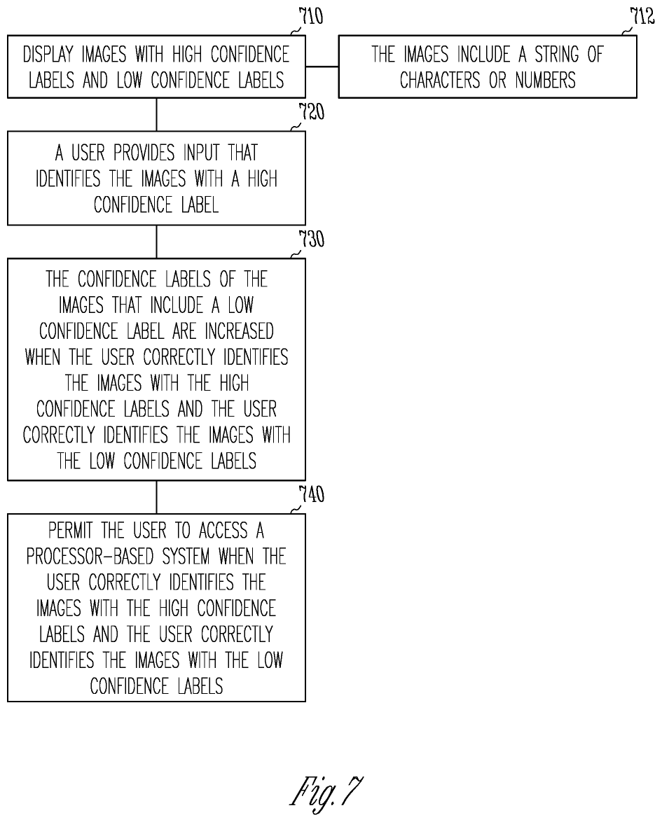

Referring now to FIG. 7, at 710, images are displayed on a computer display device. One or more of the images include a high confidence label and one or more of the images include a low confidence label. As indicated at 712, the images include a string of characters or numbers.

After viewing the images, at 720, a user provides input that identifies the images with a high confidence label. It is then determined whether the input from the user correctly identifies the images that include a high confidence label. Then, at 730, the confidence label of the one or more images that include a low confidence label are increased when the user correctly identifies the images comprising the high confidence label and the user correctly identifies the images comprising the low confidence label.

At 740, the user is permitted to access a processor-based system when the user correctly identifies the images that include high confidence labels and the user correctly identifies the images that include low confidence labels.

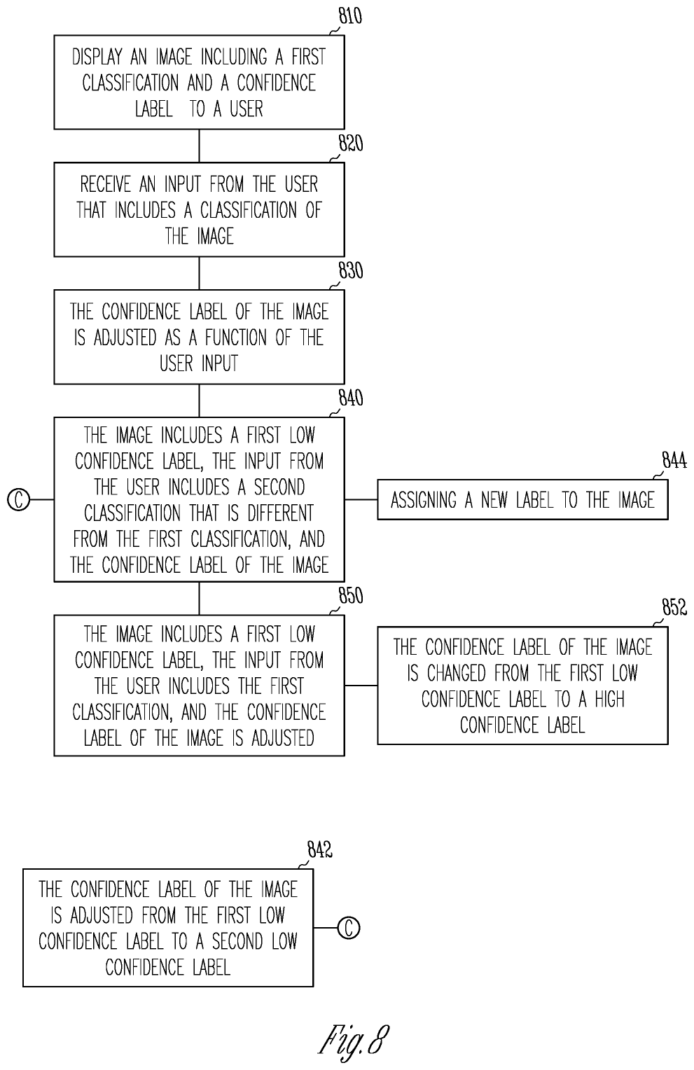

Referring now to FIG. 8, at 810, an image including a first classification and a confidence label is displayed to a user on a computer display device. At 820, an input is received from the user. The input includes a classification of the image. At 830, the confidence label of the image is adjusted as a function of the user input.

At 840, the image includes a first low confidence label, the input from the user includes a second classification that is different from the first classification, and the confidence label of the image is adjusted. At 842, the confidence label of the image is adjusted from the first low confidence label to a second low confidence label. At 844, a new label is assigned to the image. For example, from a keyboard label to a notebook label.

At 850, the image includes a first low confidence label, the input from the user includes the first classification, and the confidence label of the image is adjusted. Specifically, at 852, the confidence label of the image is changed from the first low confidence label to a high confidence label.

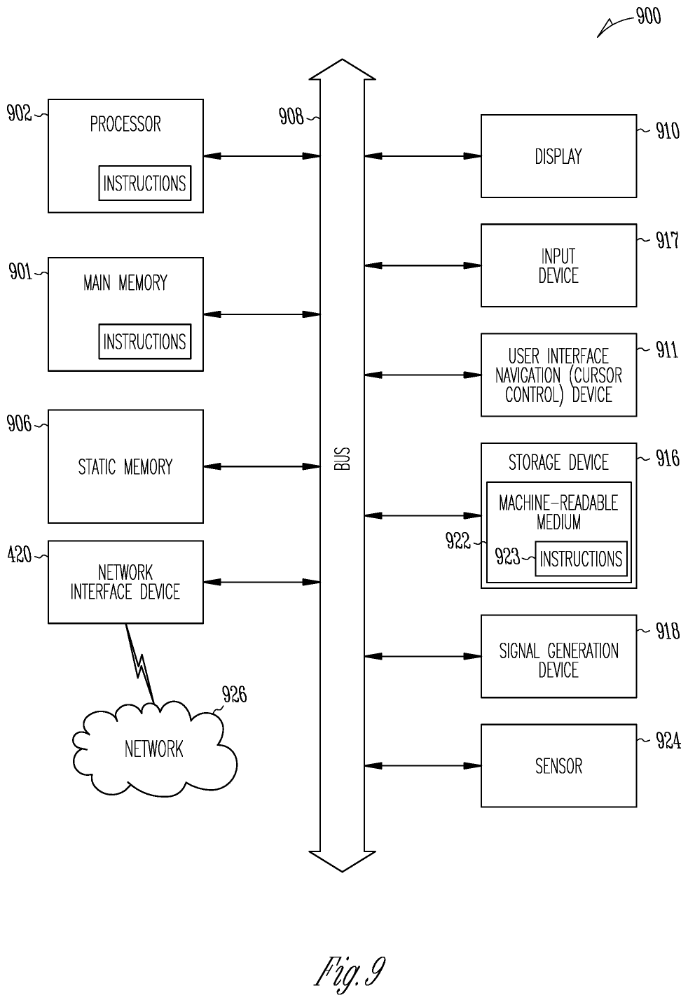

FIG. 9 is a block diagram illustrating a computing and communications platform 900 in the example form of a general-purpose machine on which some or all the operations of FIGS. 6A, 6B, 6C, 7 and 8 may be carried out according to various embodiments. In certain embodiments, programming of the computing platform 900 according to one or more particular algorithms produces a special-purpose machine upon execution of that programming. In a networked deployment, the computing platform 900 may operate in the capacity of either a server or a client machine in server-client network environments, or it may act as a peer machine in peer-to-peer (or distributed) network environments.

Example computing platform 900 includes at least one processor 902 (e.g., a central processing unit (CPU), a graphics processing unit (GPU) or both, processor cores, compute nodes, etc.), a main memory 901 and a static memory 906, which communicate with each other via a link 908 (e.g., bus). The computing platform 900 may further include a video display unit 910, input devices 917 (e.g., a keyboard, camera, microphone), and a user interface (UI) navigation device 911 (e.g., mouse, touchscreen). The computing platform 900 may additionally include a storage device 916 (e.g., a drive unit), a signal generation device 918 (e.g., a speaker), a sensor 924, and a network interface device 920 coupled to a network 926.

The storage device 916 includes a non-transitory machine-readable medium 922 on which is stored one or more sets of data structures and instructions 923 (e.g., software) embodying or utilized by any one or more of the methodologies or functions described herein. The instructions 923 may also reside, completely or at least partially, within the main memory 901, static memory 906, and/or within the processor 902 during execution thereof by the computing platform 900, with the main memory 901, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 923. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### EXAMPLES

Example No. 1 is a process comprising displaying a first image on a computer display device, the first image comprising a high confidence label; displaying a plurality of additional images on the computer display device, one or more of the plurality of additional images comprising a low confidence label; receiving input from a user, the input comprising a selection of a second image from the additional images comprising the low confidence label that matches the image comprising a high confidence label; and modifying the low confidence label of the second image.

Example No. 2 includes all the features of Example No. 1, and optionally includes a process comprising permitting the user to access a processor-based system when the user selects the second image that matches the image comprising the high confidence label.

Example No. 3 includes all the features of Example Nos. 1-2, and optionally includes a process wherein the plurality of images comprises video data.

Example No. 4 includes all the features of Example Nos. 1-3, and optionally includes a process wherein the plurality of images comprises signs of a sign language.

Example No. 5 includes all the features of Example Nos. 1-4, and optionally includes a process wherein the plurality of images is stored in a database, the database comprising images with high confidence labels, images with low confidence labels and images with no labels.

Example No. 6 includes all the features of Example Nos. 1-5, and optionally includes a process wherein the modifying of the low confidence label of the second image comprises maintaining a list of labels of the second image that were entered by a plurality of users; identifying labels of the second image that were entered by the plurality of users that match; and modifying the low confidence label of the second image when a number or percentage of the labels of the second image that were entered by the plurality of users and that match crosses a threshold.

Example No. 7 includes all the features of Example Nos. 1-6, and optionally includes a process wherein each of the plurality of additional images match the first image; and permitting the user to access a processor-based system only when the user indicates that all the additional images match the first image.

Example No. 8 includes all the features of Example Nos. 1-7, and optionally includes a process wherein none of the plurality of additional images match the first image; and permitting the user to access a processor-based system only when the user indicates that none of the plurality of additional images match the first image.

Example No. 9 includes all the features of Example Nos. 1-8, and optionally includes a process comprising using the plurality of additional images to train a machine learning algorithm.

Example No. 10 includes all the features of Example Nos. 1-9, and optionally includes a process wherein the high confidence label comprises a certainty in a range of approximately 90% to 100%.

Example No. 11 includes all the features of Example Nos. 1-10, and optionally includes a process wherein the modifying the low confidence label of the second image comprises increasing the low confidence label of the second image.

Example No. 12 is a process comprising displaying a plurality of images on a computer display device, wherein one or more of the images comprise a high confidence label and one or more of the images comprise a low confidence label; receiving input from a user; determining whether the input from the user identifies the images comprising a high confidence label; and increasing the confidence label of the one or more images comprising a low confidence label when the user correctly identifies the images comprising the high confidence label and the user correctly identifies the images comprising the low confidence label.

Example No. 13 includes all the features of Example No. 12, and optionally includes a process wherein the plurality of images comprises a string of characters or numbers.

Example No. 14 includes all the features of Example Nos. 12-13, and optionally includes a process comprising permitting the user to access a processor-based system when the user correctly identifies the images comprising the high confidence label and the user correctly identifies the images comprising the low confidence label.

Example No. 15 is a process comprising displaying an image comprising a first classification and a confidence label to a user; receiving an input from the user, the input comprising a classification of the image; and adjusting the confidence label of the image as a function of the user input.

Example No. 16 includes all the features of Example No. 15, and optionally includes a process wherein the image comprises a first low confidence label; the input from the user comprises a second classification that is different from the first classification; and adjusting the confidence label of the image.

Example No. 17 includes all the features of Example Nos. 15-16, and optionally includes a process comprising changing the confidence label of the image from the first low confidence label to a second low confidence label.

Example No. 18 includes all the features of Example Nos. 15-17, and optionally includes a process comprising assigning a new label to the image.

Example No. 19 includes all the features of Example Nos. 15-18, and optionally includes a process wherein the image comprises a first low confidence label; the input from the user comprises the first classification; and adjusting the confidence label of the image.

Example No. 20 includes all the features of Example Nos. 15-19, and optionally includes a process comprising changing the confidence label of the image from the first low confidence label to a high confidence label.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A process comprising:
displaying a first image on a computer display device, the first image comprising a high confidence label;
displaying a plurality of additional images on the computer display device, one or more of the plurality of additional images comprising a low confidence label;
receiving input from a user, the input comprising a selection of a second image from the additional images comprising the low confidence label that matches the image comprising a high confidence label; and
modifying the low confidence label of the second image.

2. The process of claim 1, comprising permitting the user to access a processor-based system when the user selects the second image that matches the image comprising the high confidence label.

3. The process of claim 1, wherein the plurality of images comprises video data.

4. The process of claim 1, wherein the plurality of images comprises signs of a sign language.

5. The process of claim 1, wherein the plurality of images is stored in a database, the database comprising images with high confidence labels, images with low confidence labels and images with no labels.

6. The process of claim 1, wherein the modifying of the low confidence label of the second image comprises:
maintaining a list of labels of the second image that were entered by a plurality of users;
identifying labels of the second image that were entered by the plurality of users that match; and
modifying the low confidence label of the second image when a number or percentage of the labels of the second image that were entered by the plurality of users and that match crosses a threshold.

7. The process of claim 1, wherein each of the plurality of additional images match the first image; and permitting the user to access a processor-based system only when the user indicates that all the additional images match the first image.

8. The process of claim 1, wherein none of the plurality of additional images match the first image; and permitting the user to access a processor-based system only when the user indicates that none of the plurality of additional images match the first image.

9. The process of claim 1, comprising using the plurality of additional images to train a machine learning algorithm.

10. The process of claim 1, wherein the high confidence label comprises a certainty in a range of approximately 90% to 100%.

11. The process of claim 1, wherein the modifying the low confidence label of the second image comprises increasing the low confidence label of the second image.

12. A process comprising:
displaying a plurality of images on a computer display device, wherein one or more of the images comprise a high confidence label and one or more of the images comprise a low confidence label;
receiving input from a user;
determining whether the input from the user identifies the images comprising a high confidence label; and
increasing the confidence label of the one or more images comprising a low confidence label when the user correctly identifies the images comprising the high confidence label and the user correctly identifies the images comprising the low confidence label.

13. The process of claim 12, wherein the plurality of images comprises a string of characters or numbers.

14. The process of claim 12, comprising permitting the user to access a processor-based system when the user correctly identifies the images comprising the high confidence label and the user correctly identifies the images comprising the low confidence label.

15. A process comprising:
displaying an image comprising a first classification and a confidence label to a user;
receiving an input from the user, the input comprising a classification of the image; and
adjusting the confidence label of the image as a function of the user input.

16. The process of claim 14, wherein the image comprises a first low confidence label; the input from the user comprises a second classification that is different from the first classification; and adjusting the confidence label of the image.

17. The process of claim 15, comprising changing the confidence label of the image from the first low confidence label to a second low confidence label.

18. The process of claim 16, comprising assigning a new label to the image.

19. The process of claim 14, wherein the image comprises a first low confidence label; the input from the user comprises the first classification; and adjusting the confidence label of the image.

20. The process of claim 18, comprising changing the confidence label of the image from the first low confidence label to a high confidence label.
